(19) United States
(12) Patent Application Publication
(10) Pub. No.: US 2009/0004352 A1
(43) Pub. Date: Jan. 1, 2009

(54) Method of Frying Minced Meat

(76) Inventor: Jens L. Adler-Nissen, Hellerup (DK)

Correspondence Address: KLEIN, O'NEILL & SINGH, LLP, 43 CORPORATE PARK, SUITE 204, IRVINE, CA, 92606, US

(21) Appl. No.: 11/817,479

(22) PCT Filed: Feb. 24, 2006
(86) PCT No.: PCT/DK2006/000110

§ 371 Date: Jul. 14, 2008

(30) Foreign Application Priority Data
Mar. 2, 2005 (DK) PA 2005 00316

(51) Int. Cl. A23L 1/01

(52) U.S. Cl. 426/523

(57) ABSTRACT

A method of frying minced meat includes the steps of providing a heated frying surface, providing a flow of discrete and separate particles of minced meat in a condition wherein the mean temperature of the flow of particles is less than 5 degrees centigrade, and heating the discrete particles to the onset of frying conditions, defined as a discernible change of the color of the particles from the original red meat color to a grey and brownish color, by bringing the particles into contact with the heated frying surface.

The present invention relates to a method of frying minced meat.

The frying of minced meat in industrial scale is difficult to perform satisfactorily such that discrete and separate particles of fried minced meat are formed because the minced meat tends to agglomerate, exude water and be cooked or boiled in said water. To avoid this it is necessary to stir the minced meat vigorously to prevent the formation of lumps and sometimes also mechanically disintegrate lumps already formed. This is difficult to carry out in industrial scale processes.

For many products, such as spring rolls, egg rolls, mince, chili con came, tacos, burritos, pasta meat sauce, and the like, it is desirable to provide discrete particles of minced meat having a fried surface and the consequent fried taste and ease of distribution in the finished product.

According to the invention this is achieved by the method comprising the steps of:
providing a heated frying surface,
providing a flow of discrete and separate particles of minced meat in a condition wherein the mean temperature of said flow of particles is less than 5 degrees centigrade, preferably less than 2 degrees centigrade and most preferably less than 0.5 degrees centigrade, and
heating said discrete particles to the onset of frying conditions defined as a discernible change of the colour of the particle from the original red meat colour to a grey and brownish colour by bringing said discrete particles into contact with said heated frying surface.

It has turned out that when minced meat is cooled to a mean temperature below 5 degrees centigrade, the tendency of the discrete particle thereof to agglomerate and thereby exude water before the surface thereof has been cauterized by frying, is reduced to such an extent that the desired discrete particles of minced meat having a fried surface can be produced in industrial scale.

In a currently preferred embodiment of the method according to the invention, said flow of discrete particles of minced meat is in a condition wherein at least a portion of the water content thereof is at a temperature below zero degrees centigrade. This condition can be assessed by measuring the enthalpy content of the partially frozen meat by calorimetry, and it is characterised by a numerical difference in enthalpy content of 30 kJ/kg and above between the partially frozen meat and the same meat at 5° C.

There are several methods for producing minced meat in discrete particles below 5° C. and, preferably, in a partially frozen state. One method, which has been used in the examples in the following, is to provide frozen minced meat in lumps of 100-500 g, either by freezing such portions of minced meat or by breaking already frozen minced meat blocks into pieces by suitable machinery, followed by disintegration of the lumps by suitable machinery, such as a high-speed bowl chopper. Meat may also be partially frozen during the chopping process, for example by mixing the meat with dry ice during chopping.

In a preferred embodiment of the invention the fat content of the meat should be between 15 and 18%. A lower fat content increases the tendency of agglomeration, while a higher fat content produces an excess of molten fat in the frying equipment.

The heating of the discrete particles minced meat to the onset of frying conditions should be done fairly rapidly to avoid agglomeration during heating. In a currently preferred embodiment of the method, frying conditions should be reached in less than five minutes from the initial contact with the frying surface. It is therefore important to choose proper frying equipment, which can provide sufficient heat transfer and also to ensure that the equipment is not overloaded, i.e. that the proportion between the mass of meat and the frying surface area is not too high.

Equipment well suited for carrying out the frying of the discrete particles of minced meat is disclosed in U.S. Pat. No. 6,331,323, the disclosure of which is hereby incorporated herein by reference.

### EXAMPLE 1

Fresh minced beef (chopped and passed through 5 mm holes) with a fat content of 15-18% was provided from a local butcher. The meat was divided into lumps of about 125 g, put in plastic bags and frozen at −18° C. Four of the frozen lumps were placed in a high-speed bowl chopper (Kilia, bowl diameter 57 cm) and chopped at lowest speed until the lumps had disintegrated into particles of 5 mm and less. The meat was then weighed into portions of 100 g each and subsequently fried using the “continuous wok” described in J. Adler-Nissen, 2002. “The Continuous Wok—A New Unit Operation in Industrial Food Processes”. J. Food Process Engin. 25: 435-453. The temperature of the frying tube was varied between 200° C. and 275° C., and the frying time between 90 s and 365 s. The processed meat was recovered and sieved through a 10 mm mesh; the proportion of meat that did not pass the mesh was used to assess, if any significant agglomeration had taken place. The product was also inspected visually, and colour, taste, and texture (mouth feel) were evaluated to judge if a suitable sensory quality had been reached.

A frying temperature of 225° C. and frying times between 120 s and 225 s resulted in a good sensory quality and a pass of the particles through the 10 mm mesh above 95%. There were no particles substantially larger than mesh opening left on the mesh. The product and process conditions were deemed satisfactory.

A frying temperature of 200° C. and frying times between 150 s and 300 s resulted in a good sensory quality and a pass of the particles through the 10 mm mesh above 95%. There were no particles substantially larger than mesh opening left on the mesh. The product and process conditions were deemed satisfactory.

A frying temperature of 250° C. and frying times between 100 s and 225 s resulted in a good, although slightly dry sensory quality and a pass of the particles through the mm mesh above 95%. There were no particles substantially larger than mesh opening left on the mesh. The product and process conditions were deemed satisfactory.

A frying temperature of 275° C. resulted in burned particles of unsatisfactory sensory quality at any process time of 90 s and above.

### EXAMPLE 2

100 g portions of minced meat were fried as described in example 1. Frying temperature was 200° C. and frying time 100 s. The product was incompletely fried, as judged by visual inspection, and more than 50% of the product did not pass the mesh. The product and process conditions were deemed unsatisfactory because of a too low temperature combined with a short frying time.

### EXAMPLE 3

100 g portions of minced meat were fried as described in example 1. Frying temperature was 250° C. and frying time 365. The product was over-fried, with a burnt flavour and colour, and 40% of the product did not pass the mesh. The product and process conditions were deemed unsatisfactory because of a too high temperature combined with a long frying time.

### EXAMPLE 4

200 g portions (double portions) of minced meat were fried as described in example 1. Frying temperature was 225° C. and frying time 145 s. The product was inhomogeneous, consisting of large lumps that were incompletely fried, together with particles of satisfactory size and sensory quality. The product and process conditions were deemed unsatisfactory because of overloading the frying surface with too much raw material.

1. A method of frying minced meat comprising the following steps:
providing a heated frying surface,
providing a flow of discrete and separate particles of minced meat in a condition wherein the mean temperature of said flow of particles is less than 5 degrees centigrade, and
heating said discrete particles to the onset of frying conditions defined as a discernible change of the color of the particle from the original red meat color to a grey and brownish color by bringing said discrete particles into contact with said heated frying surface.

2. A method according to claim 1, wherein said flow of discrete particles of minced meat is in a condition wherein at least a portion of the water content thereof is frozen.

3. A method according to claim 1, wherein said flow of discrete particles of minced meat is in a condition wherein said flow of particles requires the supply of at least 30 kJ to bring the mean temperature of one kg of said flow of particles up to 5 degrees centigrade.

4. A method according to claim 1, wherein the fat content of the meat is between 25 and 18%.

5. A method according to claim 1, wherein said onset of frying conditions is achieved in less than 5 minutes from initial contact of the discrete particle with said heated surface.

6. A method according to claim 1 and comprising the further steps of:
mincing portions of meat,
cooling the formed portions of minced meat, and
processing said cooled portions of minced meat so as to form said discrete particles of minced meat.

7. A method according to claim 1 and comprising the further steps of:
cooling a piece of meat, and
processing said cooled piece of meat so as to form said discrete particles of minced meat.

8. A method according to claim 1 and comprising the further steps of:
processing a piece of meat so as to form separate particles of minced meat, and
cooling said separate particles of minced meats substantially individually so as to form said discrete particles of minced meat.

9. A method according to claim 1 and comprising the further steps of:
supplying said discrete particles to said heated surface for bringing them into direct heat conducting contact therewith,
providing stirring means,
stirring the discrete particles so that the orientation of the discrete particles with respect to the heated surface is altered such that various surface portions of the discrete particles are brought into heat conducting contact with the heated surface,
providing scraping means adjacent the heated surface,
scraping the area of the heated surface contacted by the discrete particles so as to remove any layer of material originating from the meat and adhering to the heated surface, and
removing the discrete particles from contact with the heated surface in stir-fried condition.

10. A method according to claim 9, wherein the stirring means and at least part of the scraping means are interconnected.

11. A method according to claim 9, wherein at least part of the scraping means is fixed to the stirring means.

12. A method according to claim 9, wherein the discrete pieces are supplied to the heated surface at a first portion thereof and are removed from the heated surface at a second portion thereof, at least one of the stirring means and the scraping means being adapted to transfer the discrete pieces from the first portion to the second portion.

13. A method according to claim 12, wherein the heated surface comprises a substantially circular cylindrical body, and the stirring means comprise a helical body arranged for rotation at least partly within and in close proximity to said cylindrical body and extending from said first portion of the heated surface to said second portion of the heated surface such that rotation of the helical body transfers the discrete pieces along the cylindrical body substantially parallel to the axis thereof from said first portion to said second portion.

14. A method according to claim 9, wherein the heated surface comprises a generally circular cylindrical bowl-shaped portion with a substantially vertical axis of symmetry, the discrete pieces being introduced into contact with the heated surface batch-wise and removed therefrom batch-wise after being stir-fried.

15. A method according to claim 14, wherein the stirring means comprise a propeller-like element having one or more propeller wings shaped in conformity with the bottom portion of the bowl-shaped portion arranged for rotation around said axis of symmetry such that the wings sweep the entire area of the bottom of the bowl-shaped portion and the adjacent region of the side surface of the bowl-shaped portion, the discrete pieces being introduced batch-wise into contact with said swept area and removed batch-wise therefrom after being stir-fried.

16. A method according to claim 1, wherein the heated surface comprises a substantially circular cylindrical body arranged for rotation about the axis thereof, and the scraping means and stirring means comprise flexible means arranged for contacting the interior surface of the cylindrical body and for movement relative to said interior surface.
